(19) United States
(12) Patent Application Publication
(10) Pub. No.: US 2022/0064459 A1
(43) Pub. Date: Mar. 3, 2022

(54) INK COMPOSITION AND METHOD FOR PRODUCING INK COMPOSITION

(71) Applicant: Seiko Epson Corporation, Tokyo (JP)

(72) Inventors: Makoto KATO, Shiojiri (JP); Takeyoshi USHIKI, Shiojiri (JP)

(21) Appl. No.: 16/761,514

(22) PCT Filed: Oct. 19, 2018
(86) PCT No.: PCT/JP2018/039055

§ 371 Date: Jul. 14, 2021

(30) Foreign Application Priority Data
Nov. 6, 2017 (JP) 2017-213521

(51) Int. Cl. C09D 11/037; C09D 11/14; C09D 11/033; C09D 11/328

(52) U.S. Cl. CPC C09D 11/037; C09D 11/328; C09D 11/033; C09D 11/14

(57) ABSTRACT

An ink composition contains colored cellulose fibers and a dispersion medium containing water and a water-soluble organic solvent in a weight percentage of 1% to 95%. The ink composition contains colored cellulose fibers acting as the color material capable of being easily trapped in the meshes of the printing medium, that is, the color material having a small diffusion coefficient into the printing medium, and has a wettability as high as a contact angle of 90 degrees or less on the printing medium. Thus, the bleeding and strike-through of the ink composition can be prevented when the printing medium is printed.

### CROSS REFERENCE TO RELATED APPLICATIONS

This application is a U.S. National Stage Application of International Application No. PCT/JP2018/039055, filed on Oct. 19, 2018, and published in Japanese as WO 2019/087826 A1 on May 9, 2019, which claims priority to Japanese Patent Application No. 2017-213521, filed on Nov. 6, 2017. The entire disclosures of the above applications are incorporated herein by reference.

### TECHNICAL FIELD

The present invention relates to an ink composition and a method for producing an ink composition.

### BACKGROUND ART

There is known an ink jet printing method as a printing method using an ink composition. In the ink jet printing method, an ink is applied for printing onto a printing medium, such as a paper sheet, by ejecting small droplets of the ink. The ink jet printing method is being innovatively developed and is accordingly being adopted as a technique for high-resolution image recording (image printing) that has been performed by offset printing.

Japanese Unexamined Patent Application Publication No. 2014-76653 discloses a printing method for printing significant information on a paper sheet by using a dispersion liquid containing small cellulose fibers colored with a coloring agent as such a printing method using an ink composition.

In an embodiment of the printing method disclosed in Japanese Unexamined Patent Application Publication No. 2014-76653, before printing the dispersion liquid containing small cellulose fibers colored with a coloring agent on a paper sheet, the water content in the paper sheet is controlled to 9% to less than 85%. As the water content of a paper sheet is increased, the fiber meshes of the paper sheet expand. Accordingly, the dispersion liquid applied onto such a sheet is likely to pass through the sheet from the front side to the rear side and bleed, thus causing what is called strike-through. On such a sheet, in addition, the dispersion liquid requires time to dry and, accordingly, tends to diffuse over the surface of the sheet and cause the color material to spread, thus resulting in bleeding. Thus, the printing method disclosed in PTL 1 is not suitable for high-quality printing.

### SUMMARY

The present invention has been made to solve at least some of the above issues, and the following embodiments, or application examples, of the invention can be provided.

[Application Example 1] An ink composition according to an embodiment contains colored cellulose fibers and a dispersion medium. The dispersion medium contains water and a water-soluble organic solvent, and the weight percentage of the water-soluble organic solvent to the dispersion medium is 1% to 95%.

Since the colored cellulose fibers in the ink composition of the present embodiment have larger volumes than the molecule of the dye used as the color material of the inks generally used in the ink jet method, the cellulose fibers are likely to be caught by the printing medium made of pulp or cotton, more specifically, trapped into the fiber meshes of paper, nonwoven fabric, cloth, or the like. Thus, a large proportion of the colored cellulose fibers is likely to be distributed at the surface of the printed medium. The ink composition of the present embodiment can prevent the strike-through of the ink composition and enables high-definition printing with high color developability.

In addition, by using in the ink composition a dispersion medium containing water and a water-soluble organic solvent and in which the weight percentage of the water-soluble organic solvent is controlled to 1% to 95% relative to the ink composition, the ink composition is improved in wettability on the printing medium, and the absorption of the ink composition into the printing medium is promoted. Consequently, bleeding into the surface of the printing medium is prevented. Thus, an ink composition capable of achieving high-definition printing is provided.

[Application Example 2] In the printing composition described above, the cellulose fibers may be colored with a coloring agent selected from the group consisting of a reactive dye, a direct dye, a sulfur dye, and a vat dye.

The cellulose fibers colored with such a coloring agent are the largest of the constituents of the ink composition in terms of weight per unit volume or volume per unit molecule. Such cellulose fibers act as the color material of the ink composition. This color material is larger than the molecule of the dye used as the color material of inks generally used in the ink jet method. Accordingly, the color material is unlikely to pass through the fiber meshes of the printing medium made of, for example, paper, nonwoven fabric, or cloth. Thus, the ink composition of the embodiment can be a dye-based ink composition that does not cause strike-through when used for printing.

[Application Example 3] In the ink composition of the above embodiments, the cellulose fibers may have an average width of 2 nm to 10 μm and a length-to-width aspect ratio (length of the fibers/width of the fibers) of 100 or more.

Such cellulose fibers are smaller than the size (about 10 μm) into which pulp typically used as the printing medium is generally defibrated. Accordingly, the contact area of the cellulose fibers with the fibers defining the meshes of the printing medium, more specifically, a paper sheet, increases, and the diffusion of the cellulose fibers decreases in the thickness direction. Thus, the ink composition is prevented from striking through the printing medium and can achieve high-definition printing.

[Application Example 4] The contact angle of the ink composition of the above embodiments with the printing medium may be 90 degrees or less.

When the contact angle of the ink composition is 90 degrees or less, the absorption speed of the ink composition into the printing medium increases. According to the present embodiment, the ink composition is prevented from bleeding into the surface of the printing medium and striking through the printing medium.

[Application Example 5] A method according to an embodiment for producing an ink composition includes a step of coloring cellulose fibers, and a step of mixing the colored cellulose fibers and a dispersion medium. The dispersion medium contains water and a water-soluble organic solvent, and the weight percentage of the water-soluble organic solvent to the dispersion medium is 1% to 95%.

In the present embodiment, by controlling the weight percentage of the water-soluble organic solvent in the dispersion medium in the range of 1% to 95%, the ink composition is improved in wettability on the printing medium and absorption speed into the printing medium. Thus, there is provided an ink composition prevented from striking thorough the printing medium and from bleeding into the surface of the printing medium.

[Application Example 6] In the method of the above embodiment, the step of coloring cellulose fibers may include washing the colored cellulose fibers.

In the step of washing the colored cellulose fibers, the coloring agent not fixed to the cellulose fibers is removed to reduce the amount of the unfixed coloring agent in the ink composition. Thus, an ink composition that is prevented from bleeding into and striking through the printing medium when printed can be produced.

### BRIEF DESCRIPTION OF THE DRAWINGS

FIG. 1 is a microphotograph of bleeding of an ink composition containing a dispersion medium consisting of only water.

FIG. 2 is a microphotograph of bleeding of an ink composition containing a dispersion medium having a water-to-propylene glycol ratio of 95:5.

FIG. 3 is a microphotograph of bleeding of a dye ink of a comparative example containing a dispersion medium having a water-to-propylene glycol ratio of 5:95.

FIG. 4 is a microphotograph of a section of a plain paper sheet printed with an ink composition containing a dispersion medium containing 5% of propylene glycol.

FIG. 5 is a plot presenting simulated concentration distributions of the color material diffused into a plain paper sheet to a depth of 66 μm and 200 μm.

### DESCRIPTION OF EMBODIMENTS

Some of the embodiments of the present invention will now be described. The following embodiments are merely by way of example. The subject matter of the present invention can be implemented without being limited to the following embodiments, and various modifications may be made within the scope and spirit of the subject matter of the present invention. It should be noted that not all of the components disclosed in the following embodiments are necessarily essential for the subject matter disclosed herein.

<Ink Composition>

The ink composition according to the embodiments of the present disclosure is an aqueous ink composition containing colored cellulose fibers acting as a color material, and a dispersion medium. The ink composition exhibits appropriate wettability and absorption when printed on a printing medium, for example, a plain paper sheet, thus enabling high-quality images to be printed. The ink composition will now be described.

[Cellulose Fibers]

The cellulose fibers used in the embodiments of the present disclosure are obtained by defibrating a cellulose. The cellulose fibers are colored with, for example, a dye before use as a color material. Any type of cellulose fibers may be used, provided that it can be used as microfibers. The cellulose fibers may be made of cellulose recycled from, for example, pulp, cotton, paper, or rayon including cuprammonium rayon, bacterial cellulose, or cellulose derived from animals such as sea squirt.

Such cellulose fibers may be chemically treated by, for example, acetylation, hydroxyacetylation, carboxymethylation, or the like. The cellulose fibers may be chemically treated, for example, to improve the dispersion thereof in the ink composition or to increase the adsorbed thereof onto the printing medium.

Pulps include wood pulp and non-wood pulp. The wood pulp is classified into mechanical pulp and chemical pulp, and either may be used. If the pulp contains lignin, it will be colored. A type of pulp suitable for the printing medium must be selected. Chemical pulps include sulfide pulp, kraft pulp, and alkaline pulp. Any of these chemical pulps may be favorably used. Non-wood pulp may be made from any of straw, bagasse, kenaf, bamboo, reed, paper mulberry, flax, and the like.

Cotton is a plant mainly used for clothing, and any of lint, cotton staple, and cotton cloth can be used.

Paper is made of fibers taken out of pulp. Paper recycled from newspaper, milk pack-paper, or copied or printed paper may also be used.

The cellulose fibers used as microfibers may be in the form of cellulose powder produced by pulverizing cellulose to a certain particle size, and examples of such cellulose powder include KC FLOCK produced by Nippon Paper Industries, CEOLUS produced by Asahi Kasei Chemicals, and AVICEL produced by FMC.

Preferably, the cellulose fibers have an average width of 2 nm to 10 Preferably, the length-to-width aspect ratio of the cellulose fibers (aspect ratio=length of the fibers/width of the fibers) is 100 or more. Cellulose fibers having an average width of 2 nm to 10 μm can enter the meshes of the wood pulp or non-wood pulp used in the printing medium and thus ensure a large contact area, enabling printed items to have a fastness.

The cellulose fibers may be dry, wet, or dispersed in water. Any of these states may be used. If the cellulose fibers contain water, it is preferable to take into account the weight of water in the mixture of the cellulose fibers with the dispersion medium.

The coloring agent to color the cellulose fibers will now be described. Any coloring agent may be used without being limited to the following, provided that the coloring agent can color the cellulose fibers.

[Dye]

In the embodiments of the present disclosure, any dye that can color the cellulose fibers may be used as the coloring agent. Reactive dyes and sulfur dyes, which can impart high fastness to the printed item, are particularly suitable. However, the dye is not limited to these dyes, and other dyes, such as direct dyes and vat dyes, may be used. Dyes are easy to fix to the cellulose fibers and are therefore preferred as the coloring agent. Dyes are suitable for coloring the cellulose fibers as well as printing on, for example, paper, nonwoven fabric, or cloth. The molecule of dye used as the coloring agent is smaller than that of pigment. If a dye is solely used as a color material of the ink composition, the dye is more likely than pigment to cause bleeding or strike-through when printed on a printing medium.

Exemplary reactive dyes include yellow dyes, such as C.I. Reactive Yellows 2, 3, 18, 81, 84, 85, 95, 99, and 102; orange dyes, such as C.I. Reactive Oranges 5, 9, 12, 13, 35, 45, and 99; brown dyes, such as C.I. Reactive Browns 2, 8, 9, 17, and 33; Red dyes, such as C.I. Reactive Reds 1, 3, 4, 13, 15, 24, 29, 31, 33, 120, 125, 151, 206, 218, 226, and 245; violet dyes, such as C.I. Reactive Violets 1 and 24; blue dyes, such as C.I. Reactive Blues 2, 5, 10, 13, 14, 15, 15:1, 21, 49, 63, 71, 72, 75, 162, and 176 and Reactive Blues 4, 19, and 198; green dyes, such as C.I. Reactive Greens 5, 8, and 19; and black dyes, such as C.I. Reactive Blacks 1, 8, 23, and 39. In addition, commercially available reactive dyes may be used, and examples thereof include Sumifix HF, Sumifix Supra, and Sumifix (all product names, Sumika Chemtex); and Kayacion C F, Kayacion E, Kayacion E-C M, Kayacion E-L M, Kayacion A, Kayacion P, and Kayacion Pliquid (all product names, Nippon Kayaku Co., Ltd.)

Exemplary sulfur dyes include black dyes, such as C.I. Sulphur Blacks 1 and 6; blue dyes, such as C.I. Sulphur Blues 5, 7, 10, 11, and 15; green dyes, such as C.I. Sulphur Greens 3, 13, and 14; brown dyes, such as C.I. Sulphur Browns 1, 3, 4, 5, and 10; red dyes, such as C.I. Sulphur Reds 6, 10, and 11; yellow dyes, such as C.I. Sulphur Yellows 2 and 9; and orange dyes, such as C.I. Sulphur Orange 1. In addition, commercially available sulfur dyes may be used, and examples thereof include Kayaku Sulphurs and Kayaku Homodyes (all product names, Nippon Kayaku Co., Ltd.); ASATHIOs and ASATHISOLs (all product names, Asahi Chemical Co., Ltd.); and Kamiyo Carbon, Kamiyo Sulphur, and Kamiyo Vinylon (all product names, Kamiyo Chijiki Co., Ltd.)

Exemplary direct dyes include orange dyes, such as C.I. Direct Oranges 17, 26, and 102; red dyes, such as C.I. Direct Reds 2, 4, 6, 9, 17, 23, 26, 28, 31, 39, 54, 55, 57, 62, 63, 64, 65, 68, 72, 75, 76, 79, 80, 81, 83, 83:1, 84, 89, 92, 95, 99, 111, 141, 173, 180, 184, 207, 211, 212, 214, 218, 221, 223, 224, 225, 226, 227, 232, 233, 240, 241, 242, 243, and 247; violet dyes, such as C.I. Direct Violets 7, 9, 47, 48, 51, 66, 90, 93, 94, 95, 98, 100, and 101; blue dyes, such as C.I. Direct Blues 1, 15, 22, 25, 41, 62, 71, 76, 77, 80, 86, 87, 90, 98, 106, 108, 120, 158, 163, 168, 199, 200, 201, 202, and 226; yellow dyes, such as C.I. Direct Yellows 8, 11, 12, 21, 28, 33, 39, 44, 49, 50, 85, 86, 87, 88, 89, 98, 100, 110, 144, and 146; black dyes, such as C.I. Direct Blacks 17, 19, 22, 31, 32, 51, 62, 71, 74, 112, 113, 154, 168, and 195; brown dyes, such as C.I. Direct Browns 2, 95, 116, 161, and 223; and green dyes, such as C.I. Direct Greens 1, 6, 26, 59, and 89. In addition, commercially available direct dyes may be used, and examples thereof include Direct Dyes (product name, Hodogaya Chemical Co., Ltd.); Kayarus and Kayarus Cupro series (all product names, Nippon Kayaku Co., Ltd.); and Sumilight Dyes and Sumilight Supra Dyes (all product names, Taoka Chemical Co., Ltd.)

Exemplary vat dyes include red dyes, such as C.I. Vat Reds 5, 6, 13, 20, 21, 23, 26, 28, 29, 33, 37, 38, 40, 41, 42, and 48; brown dyes, such as C.I. Vat Browns 1, 5, 9, 21, 23, 24, 25, 26, 31, 34, 37, 45, 68, and 72; black dyes, such as C.I. Vat Blacks 1, 8, 9, 28, 29, and 35; blue dyes, such as C.I. Vat Blues 1, 3, 4, 7, 8, 10, 11, 13, 25, 30, 32, 33, 34, 35, 36, 37, 41, 47, and 48; orange dyes, such as C.I. Vat Oranges 1, 2, 4, 9, 11, 16, 17, 18, 19, 20, 23, and 26; violet dyes, such as C.I. Vat Violets 1:1, 2, 3, 4, 10, 17, 19, and 31; green dyes, such as C.I. Vat Greens 1, 2, 4, 5, 13, 14, and 17; and yellow dyes, such as C.I. Vat Yellows 1, 2, 3, 9, 10, 13, 18, 11, 11:1, 20, 23, 27, 29, 31, 28, and 49. In addition, commercially available vat dyes may be used, and examples thereof include Mikethrene and Mitsui Vat (all product names, DyStar); and Cibanones (product name, Huntsman).

Other dyes may also be used. Exemplary basic dyes include violet dyes, such as C.I. Basic Violets 3, 4, 11, 14, and 24 and crystal violet; blue dyes, such as C.I. Basic Blues 9, 17, 26, 53, and 54; red dyes, such as C.I. Basic Reds 1, 2, 9, 15, 18, 22, 49, and 54; blue dyes, such as C.I. Basic Blues 7, 3, 11, 26, 47, 57, 62, and 162; orange dyes, such as C.I. Basic Oranges 14 and 22; yellow dyes, such as C.I. Basic Yellows 2, 24, 29, 49, 51, 87, and 96; green dyes, such as C.I. Basic Greens 1, 4, 5, and 18; and brown dyes, such as C.I. Basic Browns 1 and 4. In addition, commercially available basic dyes may be used, and examples thereof include Basic Dyes (product names, Hodogaya Chemical Co., Ltd.); and Rhodamine Dye (product name, Taoka Chemical Co., Ltd.)

Other dyes include acid dyes, and exemplary acid dyes include yellow dyes, such as C.I. Acid Yellows 17, 23, 36, 42, 49, 116, 117, and 219; green dyes, such as C.I. Acid Greens 1, 25, 27, 41, 50, and 73; orange dyes, such as C.I. Acid Oranges 7, 5, 24, 67, and 156; red dyes, such as C.I. Acid Reds 1, 13, 14, 18, 27, 33, 48, 50, 52, 71, 80, 87, 88, 92, 94, 97, 106, 119, 114, 122, 131, 138, 151, 249, and 361; blue dyes, such as C.I. Acid Blues 45, 47, 62, 83, 90, 113, 119, 120, 129, 168, and 264; brown dyes, such as C.I. Acid Browns 14, 75, 98, 116, 163, 165, 349, and 358; black dyes, such as C.I. Acid Blacks 1, 2, and 234 and Eriochrome Black T; and violet dyes, such as C.I. Acid Violets 7, 17, 54, 68, and 90. In addition, commercially available acid dyes may be used, and examples thereof include Kayacyl, Kacyanol, Kayanol, Milling, Kaykalan, and Kayalax (all product names, Nippon Kayaku Co., Ltd.) and Sunchromine Dyes, Suminol Dyes, and Aminyl Dyes (all product names, Taoka Chemical Co., Ltd.)

Other dyes also include cationic dyes, and examples thereof include C.I. Basic Yellow 11, C.I. Basic Violet 7, C.I. Basic Red 13, C.I. Basic Red 14, C.I. Basic Blue 41, C.I. Basic Yellow 28, C.I. Basic Red 39, C.I. Basic Violet 16, and C.I. Basic Orange 21. Commercially available Kayacryl ED (product name, Nippon Kayaku Co., Ltd.) may also be used.

Other dyes also include neutral dyes, such as C.I. Basic Red 5, C.I. Acid Black 60, C.I. Acid Yellow 128, C.I. Acid Yellow 151, C.I. Acid Black 170, C.I. Acid Black 168, C.I. Acid Black 63, and C.I. Acid Orange 88.

[Dispersion Medium]

The dispersion medium used in the embodiments of the present disclosure contains water and a water-soluble organic solvent. The water-soluble organic solvent can be selected from among the water-soluble organic solvents conventionally used in ink compositions without particular limitation.

The water may be pure water or ultrapure water, such as ion exchanged water, extreme filtered water, reverse osmotic water, or distilled water. The weight percentage of water in the dispersion medium is preferably 5% to 99%.

Examples of the water-soluble organic solvent include ethylene glycol monomethyl ether, ethylene glycol monoethyl ether, ethylene glycol monopropyl ether, ethylene glycol monobutyl ether, ethylene glycol monomethyl ether acetate, diethylene glycol monomethyl ether, diethylene glycol monoethyl ether, diethylene glycol monopropyl ether, diethylene glycol monobutyl ether, diethylene glycol mono-t-butyl ether, triethylene glycol monobutyl ether, 1-methyl-1-methoxybutanol, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, propylene glycol monobutyl ether, dipropylene glycol monobutyl ether, ethylene glycol, diethylene glycol, triethylene glycol, pentamethylene glycol, 2-butene-1,4-diol, tripropylene glycol 1,2-pentanediol, 1,2-hexanediol, 1,3-propanediiol, 1,4-butanediol, 1,5-pentanediol, 1,6-hexanediol, 1,7-heptanediol, 1,8-octanediiol glycerol, 1,2,4-butanetriol, tetrahydrofuran, meso-erythritol, pentaerythritol, γ-butyrolactone, polyethylene glycol having a number average molecular weight of 2000 or less, 2-pyrrolidone, N-methyl-2-pyrrolidone, and N-ethyl-2-prrolidone. A water-soluble organic solvent may be solely used, or two or more water-soluble organic solvents may be used in combination. By adding a water-soluble organic solvent into the dispersion medium, the absorption speed into the printing medium can be increased.

The water-soluble organic solvent used in the dispersion medium may contain water. It is, therefore, preferable to take into account the water content in the water-soluble organic solvent when the dispersion medium is prepared.

In an embodiment of the present disclosure, the dispersion medium used in the ink composition may contain one or more of the constituents added to the ordinary ink compositions, such as a surfactant, a resin, a preservative, a pH adjuster, a solubilizing agent, an antioxidant, and an antifungal agent.

The surfactant can be used to increase the dispersibility of the constituents in the ink composition.

The resin can be used to increase the rub fastness of the printed ink composition.

The preservative can be used to suppress the deterioration with time of the cellulose fibers or other constituents and the printed item.

The pH adjuster can be used to control the pH of the ink composition to increase color developability, adsorption onto the printing medium, and rub fastness.

The solubilizing agent can be used to dissolve the constituents that are poorly soluble in water or the water-soluble organic solvent so that the constituents can be sufficiently mixed with the ink composition.

The antioxidant can be used to reduce the effects of air and water vapor to suppress the oxidation with time of the ink composition and the printed item.

The antifungal agent can be used to reduce mold to suppress the deterioration with time of the ink composition and the printed item.

The surfactant that can be added into the ink composition disclosed herein may be any of a nonionic surfactant, an anionic surfactant, a cationic surfactant, an amphoteric surfactant. Such surfactants may be used in combination.

The nonionic surfactant is preferably at least one selected from the group consisting of acetylene glycol-based surfactants, acetylene alcohol-based surfactants, fluorosurfactants, and polysiloxane-based surfactants.

Examples of acetylene glycol-based surfactants and acetylene alcohol-based surfactants include, but are not limited to, 2,4,7,9-tetramethyl-5-decyne-4,7-diol and alkylene oxide adducts thereof, and 2,4-dimethyl-5-decyne-4-ol and 2,4-dimethyl-5-decyne-4-ol and alkylene oxide adducts thereof, 3,6-dimethyl-4-octyne-3,6-diol, 3,5-dimethyl-1-hexyne-3-ol, 2,4-dimethyl-5-hexyne-3-ol acetylene adducts. At least one may be selected from among these surfactants. Acetylene glycol-based surfactants and acetylene alcohol-based surfactants are commercially available, and examples thereof include Surfynols 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, and GA (all product names, produced by Air Products and Chemicals Inc.), Olfines B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all product names, produced by Nissin Chemical Industry Co., Ltd.), and Acetylenols E00, E00P, E40, and E100 (all product names, produced by Kawaken Fine Chemicals Co., Ltd.)

A commercially available fluorosurfactant may be used, and examples thereof include Megafac F-479 (produced by DIC Corporation) and BYK-340 (produced by BYK Japan KK).

A commercially available polyorganopolysiloxane-based surfactant may be used, and examples thereof include Olfine PD-501, Olfine PD-502, and Olfine PD-570 (all produced by Nissin Chemical Industry Co., Ltd.); and BYK-347 and BYK-348 (both produced by BYK).

Further materials that can be used as a nonionic surfactant include, for example, polyoxyethylene alkyl ethers, polyoxyethylene alkylphenyl ethers, alkyl glycosides, polyoxyalkylene glycol alkyl ethers, polyoxyalkylene glycols, polyoxyalkylene glycol alkylphenyl ethers, sucrose fatty acid esters, polyoxyethylene fatty acid esters, polyoxyethylene sorbitan fatty acid esters, sorbitan fatty acid esters, polyoxyalkylene acetylene glycols, polyoxyalkylene glycol alkylamines, polyoxyethylene alkylamines, polyoxyethylene alkylamine oxides, fatty acid alkanolamides, alkylolamides, and polyoxyethylene-polyoxypropylene block polymers.

Examples of the anionic surfactant include higher fatty acid salts, soap, α-Sulfo fatty acid methyl ester salts, linear alkylbenzene sulfonates, alkylsulfate ester salts, alkyl ether sulfate salts, monoalkyl phosphate ester salts, α-olefin sulfonates, alkylbenzene sulfonates, alkylnaphthalene sulfonates, naphthalene sulfonates, alkane sulfonates, polyoxyethylene alkyl ether sulfates, sulfosuccinates, and polyoxyalkylene glycol alkyl ether phosphates.

Examples of the cationic surfactant include quaternary ammonium surfactants, such as alkyltrimethyl ammonium salts, dialkyldimethyl ammonium salts, and alkyldimethyl benzyl ammonium salts, and amine salts, such as N-methylbishydroxyethylamine fatty acid ester hydrochlorides.

Examples of the amphoteric surfactant include amine-based surfactants, such as alkylamino fatty acid salts, betaine-based surfactants, such as alkylcarboxybetaines, and amine oxide-based surfactants, such as alkylamine oxides. The amphoteric surfactant is not limited to these surfactants.

When a surfactant is added into the dispersion medium, the percentage of the surfactant to the dispersion medium is preferably 0.1% to 3% by weight.

The ink composition of an embodiment of the present disclosure may contain a resin. The resin may be contained in the form of emulsion in the dispersion medium or may be dissolved in the dispersion medium. The resin may function as the dispersant of the dyed cellulose fibers. Alternatively, the resin may be added to increase the fixability of the ink and increase the rub fastness of the printed ink on the printing medium of the printed item.

Examples of the resin in the resin emulsion include urethane resin, styrene-acrylic resin, and acrylic resin. The dispersion medium may contain a resin emulsion containing at least one of such resin components.

Any urethane resin can be used without particular limitation, provided that it has a urethane bond, and the urethane resin may be a polyether-type urethane resin further having an ether bond in the main chain, a polyester-type urethane resin further having an ester bond in the main chain, or a polycarbonate-type urethane resin further having a carbonate linkage in the main chain, each in addition to the urethane bond.

Examples of commercially available styrene-acrylic resins include, but are not limited to, Mowinyl 966A and Mowinyl 7320 (both produced by Nippon Synthetic Chemical Industry Co., Ltd.); Micro Gel E-1002 and Micro Gel E-5002 (both produced by Nippon Paint Co., Ltd.); VONCOAT 4001 and VONCOAT 5454 (both produced by DIC Corporation); SAE 1014 (produced by Zeon Corporation); Saivinol SK-200 (produced by Saiden Chemical Industry Co., Ltd.); JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 74J, JONCRYL HRC-1645J, JONCRYL 734, JONCRYL 852, JONCRYL 7600, JONCRYL 775, JONCRYL 537J, JONCRYL 1535, JONCRYL PDX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780, and JONCRYL 7610 (all produced by BASF); and NK Binder R-5HN (produced by Shin-Nakamura Chemical Co., Ltd.)

The weight percentage of the water-soluble organic solvent to the dispersion medium is preferably 1% to 95%.

By adjusting the weight percentage of the water to the water-soluble organic solvent in the dispersion medium to a level as described above, the contact angle of the ink composition with the printing medium can be controlled to 90 degrees or less. When the contact angle of the ink composition with the printing medium is 90 degrees or less, the absorption speed of the ink composition into the printing medium increases. Accordingly, the ink composition can be prevented from bleeding into the surface of the printing medium and striking through the printing medium, thus achieving high-definition printing.

For simply measuring the contact angle of the ink composition with the printing medium, 2 μL (microliters) of the ink composition is dropped from a dispenser onto a printing medium, more specifically, a plain paper sheet (highly white wood-free paper sheet produced by Oji Paper), and a still picture of the droplet is taken with a digital camera or a video camera in the direction horizontal to the surface on which the droplet lies, followed by image analysis.

For accurate measurement of the contact angle can be used a portable contact angle meter PCA-11, a full automatic contact angle meter DMo-1101, contact angle meters DMo-501 and DMs-401, and a simple contact angle meter DMe211, all provided by Kyowa Interface Science Co., Ltd.; and Phoenix-300 Touch, Phoenix-Alpha, Phoenix-Pico Touch, all provided by Meiwafosis Co., Ltd.

<Method for Producing Ink Composition>

A method for producing the ink composition, according to an embodiment of the present disclosure will now be described. The method for producing the ink composition of the embodiments of the present disclosure includes a step of coloring cellulose fibers, and a step of mixing the colored cellulose fibers and a dispersion medium.

An exemplary implementation of the step of coloring cellulose fibers in an embodiment will first be described. In the embodiment disclosed herein, a reactive dye is used. However, the coloring step is not limited to using such a dye, and other dyes, such as sulfur dyes and direct dyes, may be used as the coloring agent.

The cellulose fibers are colored with a reactive dye. BiNFi-s provided by Sugino Machine Limited is used as the cellulose fibers. Sumifix Brill. Red 38F 150% gran. provided by Sumika Chemtex Company, Limited is used as the reactive dye. First, an aqueous solution of dye is prepared by dissolving 5 wt% of the dye in water. The cellulose fibers are added to the dye aqueous solution so that the weight percentage of the fibers to the dye aqueous solution can be 2.25%, and mirabilite (50 g/L (litter)) and soda ash (10 g/L) are added to the dye aqueous solution. The mixture is heated to 60° C. with stirring and kept heating for 40 minutes.

Before the addition to the dye aqueous solution, the cellulose fibers may be preliminarily defibrated. The preliminary defibration increases the frequency of contact of the cellulose fibers with the dye in the dye aqueous solution, helping to color the cellulose fibers uniformly and efficiently.

Next, the dyed cellulose fibers are boiled for 10 minutes in a soaping solution prepared by dissolving EMILL SK-D (3 g/L) provided by Kotani Chemical Industry Co., Ltd. and sodium tripolyphosphate (1.5 g/L) in water to remove unreacted and unfixed dye. After removing the dyed cellulose fibers from the soaping solution and rinsing the fibers with water, the water content in the dyed cellulose fibers was reduced to 10% by weight by vacuum heat drying. The resulting dyed cellulose fibers will be used in the following steps.

As described above, the step of coloring (dyeing) cellulose fibers, preferably, includes a step of washing the colored (dyed) cellulose fibers to remove unreacted and unfixed dye. The method for producing the ink composition including removing unreacted and unfixed dye can provide an ink composition surely prevented from bleeding into and striking through the printing medium.

It will be appreciated that the present invention is not limited to the embodiments disclosed above and that various modifications may be made without departing from the spirit and scope of the invention. Modifications of dyeing the cellulose fibers will be described below.

(Modification 1)

The cellulose fibers are dyed with a sulfur dye. BiNFi-s provided by Sugino Machine Limited is used as the cellulose fibers, as described above. The sulfur dye to be used is ASAHI THIOSOL provided by Asahi Chemical Co., Ltd. An aqueous solution of 5% by weight of the sulfur dye in water was prepared. The cellulose fibers are added to the dye aqueous solution so that the weight percentage of the cellulose fibers to the dye aqueous solution can be 5%. Into the resulting dye aqueous solution are added 1% by weight of a level dyeing agent ASAHI NOSA 8000 (product name, produced by Asahi Chemical Co., Ltd.), soda ash (12 g/L), mirabilite (10 g/L), and THIOGEN (7 cc/L) at room temperature. The mixture is heated to 85° C. and kept heating at this temperature for 40 minutes with stirring. The cellulose fibers are removed from the dye aqueous solution and rinsed with water to remove unfixed dye. The rinsed cellulose fibers are added into clean water, and into which an oxidizing agent ASAHI OXY 50 (product name, produced by Asahi Chemical Co., Ltd., 1 cc/L) and 90% by weight aqueous solution (4 cc/L) of acetic acid. The resulting solution is heated to 40° C. and kept heating for 15 minutes with stirring to dye the cellulose fibers. After cooling, the dyed cellulose fibers are taken out and rinsed with water to remove the oxidizing agent and acetic acid. The cellulose fibers may optionally be washed with or in an organic solvent, a soaping agent, or the like.

According to Modification 1, the sulfur dye can develop a complex neutral color that cannot be provided by ordinary dyes. Also, since sulfur dyes are less expensive than other dyes, the production cost of the ink composition can be reduced.

(Modification 2)

The cellulose fibers are dyed with a direct dye. BiNFi-s provided by Sugino Machine Limited is used as the cellulose fibers, as described above. The direct dye to be used is C.I. Direct Blue 1. The cellulose fibers are added with a content of 3% by weight into a dye aqueous solution in which the direct dye content is adjusted to 1% by weight, and the mixture is heated up to 60° C. and kept heating at this temperature for 90 minutes with stirring to dye the cellulose fibers. The dyed cellulose fibers are rinsed with water to remove unfixed dye and dispersed in water to make an aqueous dispersion containing 10% by weight of dyed cellulose fibers. The cellulose fibers may optionally be washed with or in an organic solvent, a soaping agent, or the like.

Since direct dyes can very easily dye cellulose fibers, and accordingly, Modification 2 can reduce production cost.

For washing to remove unreacted or unfixed dye, a dye-dissolving or dye-dispersing organic solvent, such as ethanol or acetone, may be used as well as cold water, heated water, or boiled water. Also, commercially available products may be used, including SENKANOL C-80 and SENKANOL CW (both product names, produced by Senka Corporation); REMOVER P, EMILL SK-D, and EMILL G-100 (all product names, produced by Kotani Chemical Industry Co., Ltd.); Meisanol, Laccol, and Gran Up (all product names, produced by Meisei Chemical Works, Ltd.); Newsoaper K-3, Newsoaper K-9A, Newsoaper K-10, and Discolor N-3 (all product names, produced by Nissin Kagaku Kenkyusho Co., Ltd.); and SE Soaper 380 (product name, Enex Co., Ltd.)

Dyes capable of being easily adsorbed to cellulose fibers are preferably used as the coloring agent from the viewpoint of fixability to the cellulose fibers. The coloring dye is preferably a reactive dye or a sulfur dye, which can form a covalent bond.

The coloring agent is preferably a dye in view of the color development when the ink composition is printed on a printing medium. Since dyes have high color developability and color reproducibility, use of a dye enables high-definition printing.

If a pigment is used as the coloring agent, it is preferable to add a coupling agent to bind the pigment to the cellulose fibers from the viewpoint of enhancing the fixability to the cellulose fibers. The coupling agent to be used may be a silane coupling agent, an amine-based coupling agent, a titanate-based coupling agent, or an aluminate-based coupling agent. By coupling the pigment to the cellulose fibers, the diffusion coefficient of the color material in the printing medium can be reduced compared to the case of using only the pigment.

In addition to the coloring agent for coloring the cellulose fibers, other materials, such as a penetrant, a bath softener, a metal ion blocking agent, an antireductant, a neutral electrolyte, an alkaline agent, a pH adjuster, and an organic solvent, may be used.

A nonionic surfactant may be used as a penetrant to enhance the penetration of the dye into the fibers.

A bath softener can be used to prevent the fibers from being rubbed to deteriorate.

Sodium tripolyphosphate, sodium hexametaphosphate, or the like may be used as a metal ion blocking agent to reduce the hardness of the solution for dissolving the dye or the solution for dissolving the soaping agent.

Sodium m-nitrobenzenesulfonate or the like may be used as an antireductant to suppress the reductive decomposition of the dye and thus to prevent the color from changing.

Anhydrous mirabilite, crystalline mirabilite, salt, or the like may be used as a neutral electrolyte to increase dyeing efficiency.

Sodium carbonate, sodium hydroxide, or the like may be used as an alkaline agent to increase dyeing efficiency.

A pH adjuster, such as hydrochloric acid, sulfuric acid, sodium hydroxide, ammonia water, or urea, may be used as a chemical reaction promoter such as a hydrolysis reaction catalyst.

An organic solvent, such as ethanol, isopropyl alcohol, ethyl acetate, or toluene, may be used as a solvent to dissolve the silane coupling agent or the like.

The step of mixing the colored cellulose fibers with a dispersion medium in an embodiment will now be described. The colored cellulose fibers in an amount corresponding to a content of 0.5% by weight are added into a dispersion medium. The cellulose fibers are then preliminarily defibrated in a mixer and uniformly dispersed in the dispersion medium with a kneader to yield an ink composition. The dispersion medium may be previously prepared by mixing water and a water-soluble organic solvent, or water and the water-soluble organic solvent may be mixed when the cellulose fibers are preliminarily defibrated in a mixer or uniformly dispersed with a kneader.

It is preferable to preliminarily defibrate the colored cellulose fibers before uniformly dispersing the cellulose fibers in the step of mixing the colored cellulose fibers with the dispersion medium. This preliminary defibration reduces the number of coarse fibers and thus increases the uniformity in size of the colored cellulose fibers in the ink composition.

Also, since the preliminary defibration reduces the number of times, the time, and the like of the operation using a device to uniformly disperse the fibers, the efficiency related to the uniform dispersion can be increased, and the load on the uniformly dispersing device can be reduced.

The method for the preliminary defibration is not particularly limited and may be performed by using a refiner used for defibration, beating, purification, and the like, a high-pressure homogenizer, a grinder, or a mixer or by a water jet method.

The method for the uniform dispersion is not particularly limited and may be performed by using a high-pressure homogenizer, a grinder, a high-pressure water jet, a pressure kneader, a ball mill, a supersonic homogenizer, or the like.

More preferably, the coloring agent to color the cellulose fibers has approximately the same specific gravity as the water-soluble organic solvent in the dispersion medium, more specifically, a specific gravity of 0.9 g/cm³ to 1.6 g/cm³, in view of the storage stability of the ink composition prepared through the above-described steps. From the viewpoint of further taking into account the color developability of the ink composition, the coloring agent is more preferably a dye. Since the dye molecule has a specific gravity smaller than or approximately equal to the cellulose molecule, which has a specific gravity of 1.56 g/cm³, the dye does not much change the specific gravity of the cellulose fibers even if the cellulose fibers chemically or physically adsorb the dye. Thus, the resulting color material is not likely to settle.

If the coloring agent has a specific gravity of 1.6 g/cm³ or more, it is preferable, in view of storage stability, to circulate the ink composition to prevent the cellulose fibers acting as the color material from settling down in the apparatus in which the ink composition is used.

For preparing the dispersion medium used in the present embodiment, the weight percentage of the water-soluble organic solvent is determined so that the contact angle of the dispersion medium with the printing medium, more specifically, a plain paper sheet, can be 90 degrees or less when measured by a simple method.

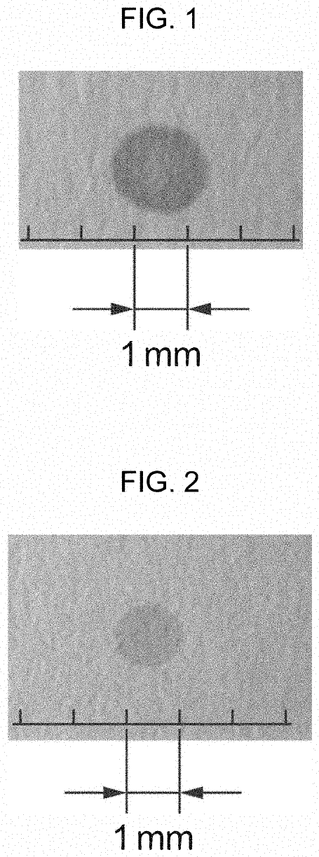

An exemplary dispersion medium of the ink composition according to an embodiment and the evaluation in the bleeding into the printing medium and the strike-through of the ink composition will now be described with reference Tables 1 to 3 and FIGS. 1 to 5.

First, Table 1 presents the relationship between the percentage in weight of the water-soluble organic solvent in the dispersion medium and the contact angle of the dispersion medium.

The water-soluble organic solvent is selected from among propylene glycol, dipropylene glycol, 1,4-butanediol, ethanol, isopropyl alcohol, n-butanol, ethylene glycol monoethyl ether, tetraethylene glycol dimethyl ether, and γ-butyrolactone. The values presented in Table 1 are contact angle measurements of the dispersion media with varying weight percentages of the water-soluble organic solvent in the respective dispersion media.

TABLE 1

| | Percentage in weight of water-soluble organic solvent in dispersion medium and | | | | | | | | | | | | | | | | |
|---|---|---|---|---|---|---|---|---|---|---|---|---|---|---|---|---|---|
| | contact angle (degree) | | | | | | | | | | | | | | | | |
| Dispersion medium | 0% | 1% | 2% | 3% | 4% | 5% | 6% | 9% | 10% | 11% | 13% | 15% | 20% | 23% | 30% | 80% | 95% |
| Water only | 112 | | | | | | | | | | | | | | | | |
| Water + propylene glycol | | | | | | 90 | | | | | | | 77 | 65 | | | 66 |
| Water + dipropylene glycol | | | | | | | | | | 100 | 100 | 95 | 90 | | NA | | NA |
| Water + tetraethylene | | 110 | 74 | | | | | 78 | 82 | | | | | | | | NA |
| glycol diethyl ether | | | | | | | | | | | | | | | | | |
| Water + isopropyl alcohol | | 94 | | 95 | | 90 | | | | NA | | | | | | | NA |
| Water + n-butanol | | 90 | | 45 | | | NA | Not mixed | | | | | | | | NA | NA |
| Water + 1,4-butanediol | | | | | | 97 | | | 98 | | | 77 | | | | | 33 |
| Water + γ-butyrolactone | | | | 90 | | 80 | | | | | | | | | | | NA |
| Water + ethanol | | | | | | 90 | | | 80 | | | | | | | | NA |
| Water + ethylene glycol | | | | | 97 | 86 | | | | | | | | | | | NA |
| monoethyl ether | | | | | | | | | | | | | | | | | |

Table 1 presents, in the lateral direction, weight percentages of a water-soluble organic solvent to the dispersion medium and, in the vertical direction, water-soluble organic solvents. NA in Table 1 represents that the contact angle cannot be measured because the plain paper momentarily absorbs the dispersion medium upon dropping a drop. Hence, NA implies that the contact angle is very small.

Table 1 shows that in all the cases of the water-soluble organic solvents, the contact angle decreases or becomes unable to be measured (NA) as the weight percentage of the water-soluble organic solvent to the dispersion medium is increased. This suggests that the contact angle can be 90 degrees or less provided that the weight percentage of the water-soluble organic solvent is higher than the lower limit of the weight percentage of the water-soluble organic solvent at which the contact angle is 90 degrees.

In Table 1, the contact angle is 90 degrees or less at the bolded cell portions (bold text). This suggests that the contact angle of the dispersion medium can be 90 degrees or less in the range where the weight percentage of the water-soluble organic solvent in the dispersion medium is from the lower limit to 95% by weight being the upper limit. Preferably, water and the water-soluble organic solvent are completely mixed without separating into phases.

When the dispersion medium is composed of only water, the contact angle is 90 degrees or more, as presented in Table 1, and the wettability on the plain paper sheet is not good. Even though a water-soluble organic, such as an ether or an alcohol, as described in PTL 1 (Japanese Unexamined Patent Application Publication No. 2014-76653), is added, the content of the water-soluble organic solvent has to be controlled so that the dispersion medium can exhibit a contact angle of 90 degrees or less to obtain an effective wettability on the plain paper sheet. More specifically, the weight percentage of the water-soluble organic solvent to the dispersion medium is 1% to 95% to obtain the ink composition of the embodiments of the present disclosure.

Next, strike-through and bleeding will be discussed. More specifically, cellulose fibers colored with a reactive dye according to an embodiment of the present disclosure were used as the color material, and ink compositions containing 1% by weight of the color material in a dispersion medium were examined. The percentage of the water-soluble organic solvent in the dispersion medium was the upper limit or the lower limit thereof presented in Table 1. For the evaluation of strike-through, 0.2 μL (microliter) of each ink composition was dropped onto a plain paper sheet. The ink composition whose color reached the rear side of the plain paper sheet is determined to be bad (unsuitable), and the ink composition whose color did not reach the rear side is determined to be good (suitable). For the evaluation of bleeding, the ink composition that did not bleed or spread from the initial diameter (about 3 mm (millimeters) of a drop of the ink composition is determined to be good (suitable), and the ink composition that caused the drop to bleed even slightly is determined to be bad (unsuitable).

Table 2 presents the evaluation results of the bleeding into plain paper and the strike-through of the ink compositions containing the upper limit weight percentage or the lower limit weight percentage of water-soluble organic solvent.

TABLE 2

| | Water-soluble | | | Water-soluble | | |
|---|---|---|---|---|---|---|
| | organic solvent | | | organic solvent | | |
| | content | | | content | | |
| Dispersion medium | (upper limit) | Bleeding | Strike-through | (lower limit) | Bleeding | Strike-through |
| Water only | — | — | — | 0% | Bad | Good |
| Water + propylene glycol | 95% | Good | Good | 5% | Good | Good |
| Water + dipropylene glycol | 95% | Good | Good | 20% | Good | Good |
| Water + tetraethylene glycol | 95% | Good | Good | 2% | Good | Good |
| diethyl ether | | | | | | |
| Water + isopropyl alcohol | 95% | Good | Good | 5% | Good | Good |
| Water + n-butanol | 95% | Good | Good | 1% | Good | Good |
| Water + 1,4-butanediol | 95% | Good | Good | 15% | Good | Good |
| Water + γ-butyrolactone | 95% | Good | Good | 3% | Good | Good |
| Water + ethanol | 95% | Good | Good | 5% | Good | Good |
| Water + ethylene glycol | 95% | Good | Good | 5% | Good | Good |
| monoethyl ether | | | | | | |

Table 2 shows that only the ink composition whose dispersion medium is composed of only water and which exhibits a contact angle of 90 degrees or more bled. The bleeding exhibited unevenness in color from the circumference of the drop (ink composition) to the center. This unevenness is a coffee stain effect caused by the Marangoni flow of a drop occurring in the course of drying. The cause of drying of the drop at the surface of the printing medium, such as a plain paper sheet, is a low wettability of the drop. The low wettability of a drop is involved in the contact angle of the drop obtained by the Lucas-Washburn equation represented by the following equation 1. The Lucas-Washburn equation shows a relationship between the contact angle 0 of a drop and an index of wetting that represented by penetration depth 1 (ell) per unit time t.

$$\begin{matrix}[ Math . 1 ] & \\ I = \sqrt{\frac{r γ cos θ}{2 η}} t & ( 1 )\end{matrix}$$

In equation 1, 1 (ell) represents penetration depth (m: meter), r represents capillary pore radius (m: meter), γ represents the surface tension of a liquid (N/m; newton per meter), θ represents the contact angle (π/180: radian), η represents the viscosity (mPa·s: millipascal·second), and t (s: second) represents time.

FIG. 1 is a microphotograph of bleeding of an ink composition containing a dispersion medium composed of only water. The ruler presented in the figure has a scale marked every 1 mm.

In the range of the water-soluble organic solvent content presented in Table 2 where the contact angle was 90 degrees or less, on the other hand, the absorption speed of a drop into the printing medium, more specifically, a plain paper sheet, was considerably higher than the speed of movement of the drop at the surface, and, accordingly, bleeding did not occur. A small contact angle of a drop implies a high absorption speed of the drop into the plain paper sheet. Such an ink composition does not exhibit the bleeding into the plain paper sheet which occurs when the ink composition whose dispersion medium is composed of only water is used.

FIG. 2 is a microphotograph of bleeding of an ink composition containing a dispersion medium having a water-to-propylene glycol ratio of 95:5. The ruler presented in the figure has a scale marked every 1 mm (millimeter).

The ink composition preferably has a viscosity as low as the extent that the ink composition can be printed by ejection of droplets, more specifically, can be ejected by a piezoelectric method, a thermal method, or any other method used in ink jet printers. More preferably, the viscosity of the ink composition is 50 mPa·s (millipascal·second) or less.

Table 3 presents the evaluation results of the bleeding and the strike-through of the dye ink of a comparative example. More specifically, in the comparative example, a dye ink prepared by dissolving a dye in only water (with a water-soluble organic solvent content of 0%) and a dye ink prepared by dissolving a dye in a dispersion medium (water : propylene glycol =5:95) were subjected evaluation in terms of bleeding into and striking through a plain paper sheet. Table 3 presents the evaluation results together.

TABLE 3

| | Water-soluble | | | Water-soluble | | |
|---|---|---|---|---|---|---|
| | organic solvent | | | organic solvent | | |
| | content | | | content | | |
| Dye ink | (upper limit) | Bleeding | Strike-through | (lower limit) | Bleeding | Strike-through |
| Dye dispersion liquid | 95% | Bad | Bad | 0% | Bad | Bad |
| (using propylene | | | | | | |
| glycol) | | | | | | |

Table 3 shows that bleeding and strike-through of the dye ink occurred in the cases of using the dispersion medium having either water-soluble organic solvent content. Dye molecules, which are sufficiently smaller than the meshes of plain paper, migrated through the meshes in the surface direction and the thickness direction of the plain paper as the dispersion medium was absorbed, independent of the composition of the dispersion medium.

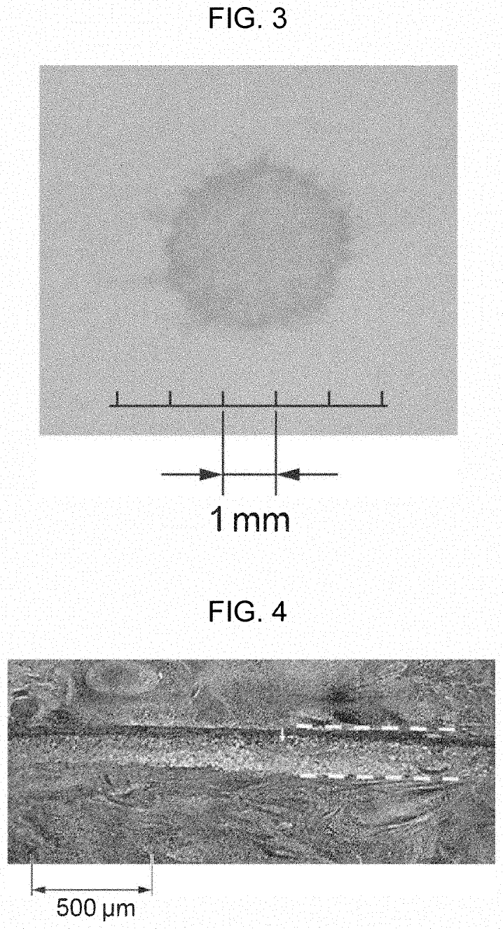

FIG. 3 is a microphotograph of bleeding of an ink composition of a comparative example containing a dispersion medium having a water-to-propylene glycol ratio of 5:95. The ruler presented in the figure has a scale marked every 1 mm (millimeter).

FIG. 3 clearly shows that the dye ink of the comparative example spreads like a tree in the surface direction. Since this diffusion occurs isotropically also in the thickness direction, it is easily understood that the dye ink can diffuse a very long distance.

An ink composition presented in Table 2 in which the weight percentage of propylene glycol was 5% to the dispersion medium was printed on a plain paper sheet, and the section of the plain paper was observed. For preparing the section, 2 μL (microliter) of the ink composition was dropped onto the plain paper, followed by drying, and the resulting printed item was embedded in a polyethylene resin member. The polyethylene resin member was cut to expose the section, and the section was observed with a microscope.

FIG. 4 is a microphotograph of the section of the plain paper sheet printed with the ink composition whose dispersion medium contains 5% of polyethylene glycol. In this figure, the upper dotted line represents the surface of the plain paper sheet on which an amount of the ink composition has been dropped, and the lower dotted line represents the rear surface of the plain paper sheet. It was observed that the colored cellulose fibers in the ink composition colored the plain paper sheet up to the position pointed by the downward arrow shown in the figure. The penetration depth of the colored cellulose fibers was about 66 μm from the surface.

The penetration of the colored cellulose fibers stopped at a depth of about 66 μm of the plain paper sheet having a thickness of 200 μm. In contrast, the dye ink of a comparative example struck through the plain paper sheet; hence, the dye molecules in the dye ink of the comparative example penetrated at least 200 μm. By using colored cellulose fibers as the color material of the ink composition, strike-through of the color material (colored cellulose fibers) can be prevented when a printing medium, more specifically, a plain paper sheet, is printed with the ink composition. Accordingly, the amount of coloring agent (dye in this instance) that can achieve color development to the same extent as the color development of the known ink can be reduced.

The concentration gradient of colored cellulose fibers or dye molecules migrating toward the rear side from the front side of the plain paper sheet on which the ink is dropped is ideally according to the Fick's diffusion equation. Even though the ink composition of an embodiment of the present disclosure provides a high concentration at the surface to the same extent as the known dye ink, strike-through can be prevented. Accordingly, the ink composition with a smaller dye content than the known ink can be printed with the same dye concentration as the known ink.

The concentration distributions of the color materials at the section of a plain paper sheet were simulated from FIG. 4 in an abbreviated manner. For the colored cellulose fibers acting as the color material, the distribution when the colored cellulose fibers are diffused 66 μm was simulated; for the color material of the dye ink, the distribution when dye molecules acting as the color material are diffused 200 μm was simulated. For the simulations, a concentration distribution of the color material in unsteady-state diffusion for a certain period was taken on the assumption that the diffusion coefficient of the color material is not varied by drying. The concentration distribution of the color material (dye) is that when the diffusion distance at which the concentration of the color material asymptotically decreases to 0 is 66 μm or 200 μm. For the concentration distributions of the color materials (dyes), ratios of the diffused dye concentration to the dye concentration (defined as 1) at the printing medium were calculated according to the respective diffusion distance.

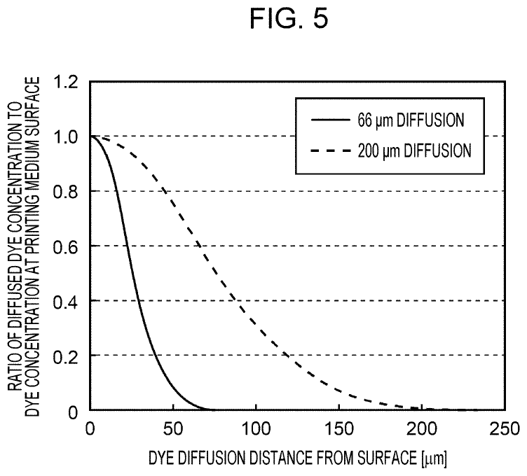

FIG. 5 is a plot showing simulated concentration distributions of the color material diffused into a plain paper sheet to a depth of 66 μm and a depth of 200 μm. More specifically, the horizontal axis of the plot represents the diffusion distance of the color material (dye) from the surface of plain paper used as the printing medium, and the vertical axis represents the ratio of the diffusion color material concentration (dye concentration) to the dye concentration at the surface of the printing medium.

The area of 66 μm diffusion and the area of 200 diffusion each represent the amount of dye. Therefore, the simulation results suggest that the ink composition that diffuses 66 μm in an amount smaller than the dye ink that diffuses 200 μm can achieve color development equivalent to the color development by the dye ink.

The simulation results described above were obtained by experiments using cellulose fibers provided by Sugino Machine Limited. However, since any colored cellulose fibers are larger than dye molecules dissolved in the known dye ink, the coefficient of diffusion of the cellulose fibers into the meshes of the printing medium, specifically, a paper sheet made of pulp, decreases. Hence, colored cellulose fibers used as the color material are unlikely to pass through the meshes of the printing medium. Although the degree of passing depends on the printing medium, this is probably common to any type of cellulose fibers.

The molecular radius of dyes having a molecular weight of up to about 2000 g/mol is several tens of nanometers. Cellulose fibers have a diameter of 2 nm to 10 μm (micrometers) and a length of about 200 nm to 1 mm, being larger than dye molecules by orders of magnitude.

Thus, according to an aspect of the present disclosure, an ink composition capable of achieving high color development can be produced by using even a small amount of dye.

The ink composition and the method for producing the same according to the embodiments of the present disclosure enable a large amount of color material to be present at the surface of the printing medium made of, for example, pulp and thus lead to high color development. Thus, the present disclosure can provide an ink composition capable of achieving high-definition printing and a method for producing such an ink composition.

1. An ink composition comprising: colored cellulose fibers; and a dispersion medium,
the dispersion medium containing water and a water-soluble organic solvent,
wherein the weight percentage of the water-soluble organic solvent to the dispersion medium is 1% to 95%.

2. The ink composition according to claim 1,
wherein the cellulose fibers are colored with a coloring agent,
the coloring agent being selected from the group consisting of a reactive dye, a direct dye, a sulfur dye, and a vat dye.

3. The ink composition according to claim 1, wherein the cellulose fibers have an average width of 2 nm to 10 μm and a length-to-width aspect ratio (length of the fibers/width of the fibers) of 100 or more.

4. The ink composition according to claim 1, wherein the contact angle of the ink composition with a printing medium is 90 degrees or less.

5. A method for producing an ink composition, comprising:
a step of coloring cellulose fibers; and
a step of mixing the colored cellulose fibers with a dispersion medium,
wherein the dispersion medium contains water and a water-soluble organic solvent, and the weight percentage of the water-soluble organic solvent to the dispersion medium is 1% to 95%.

6. The method for producing an ink composition according to claim 5, wherein the step of coloring cellulose fibers includes washing the colored cellulose fibers.

7. The ink composition according to claim 2, wherein the cellulose fibers have an average width of 2 nm to 10 μm and a length-to-width aspect ratio (length of the fibers/width of the fibers) of 100 or more.

8. The ink composition according to claim 2, wherein the contact angle of the ink composition with a printing medium is 90 degrees or less.

9. The ink composition according to claim 3, wherein the contact angle of the ink composition with a printing medium is 90 degrees or less.

10. The ink composition according to claim 7, wherein the contact angle of the ink composition with a printing medium is 90 degrees or less.
